(19) United States
(12) Patent Application Publication
(10) Pub. No.: US 2010/0036591 A1
(43) Pub. Date: Feb. 11, 2010

(54) ENGINE STOP CONTROL APPARATUS

(75) Inventor: Yasuhiro NAKAI, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/536,799

(22) Filed: Aug. 6, 2009

(30) Foreign Application Priority Data
Aug. 8, 2008 (JP) 2008-205950

(51) Int. Cl. F02D 45/00

(52) U.S. Cl. 701/112

(57) ABSTRACT

When an engine stop demand is generated and an engine speed is less than or equal to a specified value Ne1, the engine speed is increased once and the engine stop control is started. Even if the engine speed is low at a time of the engine stop demand, the engine stop control period (engine rotational angle) can be ensured. The engine stop position can be controlled to a target stop position with high accuracy.

### CROSS-REFERENCE TO RELATED APPLICATION

This application is based on Japanese Patent Application No. 2008-205950 filed on Aug. 8, 2008, the disclosure of which is incorporated herein by reference.

### FIELD OF THE INVENTION

The present invention relates to an engine stop control apparatus which controls an engine stop position (stop crank angle) when the engine is stopped.

### BACKGROUND OF THE INVENTION

As shown in JP-2005-315202A, in an engine auto stop/start system, in order to control an engine stop position (stop crank angle) in a crank angle range suitable for restarting, a target current value of an alternator is increased to an initial value then decreased when the engine is automatically stopped.

In the engine stop control apparatus shown in JP-2005-315202A, when the engine is automatically stopped, a load of an alternator is controlled so that the engine stop position is in a target crank angle range. When the engine speed is from 480 rpm to 540 rpm, the target current value of the alternator is set according to the engine speed by use of a map. Thus, the control of the alternator load is rough and a variation in an engine stop behavior can not be compensated enough.

In order to solve the above problems, a target engine speed behavior (target track) is computed. The alternator torque is controlled in such a manner that the engine speed behavior agrees with the target track.

The engine stop position adjustable range is defined based on an engine rotational angle and alternator torque. Since the alternator torque is not so large, some amounts of the engine stop control period (engine rotational angle) are necessary in order that the engine speed behavior agrees with the target track. When the engine speed becomes excessively small, the engine stop control period can not be ensured. An accuracy of the engine stop position is deteriorated.

### SUMMARY OF THE INVENTION

The present invention is made in view of the above matters, and it is an object of the present invention to provide an engine stop control apparatus which can control the engine stop position to the target stop position even if the engine speed is low when an engine stop demand is generated.

According to present invention, an engine stop control apparatus performs an engine stop control by a torque of an electric machinery in a manner that an engine stop position is controlled to a target stop position when the engine is stopped according to an engine stop demand. The engine stop control apparatus includes an engine speed accelerator which starts the engine stop control after increasing an engine speed once when an engine stop demand is generated and the engine speed is lower than a specified value.

The specified value may be established based on an engine speed at an engine stop control start timing, which is needed to ensure an accuracy of the engine stop position. When the engine speed is lower than a specified value at a time of the engine stop demand, the engine speed is increased once and then the engine stop control is started. Thus, even if the engine speed is low at a time of engine stop demand, the engine stop control period (engine rotational angle) can be ensured, so that the engine stop position can be controlled to a target stop position with high accuracy.

The engine speed accelerator advances an ignition timing, stops a compressor of air conditioner, increases an intake air quantity, or increases a fuel injection quantity. Each of the advance of the ignition timing, an increase in intake air quantity, and an increase in fuel injection quantity increases the engine torque, so that the engine speed is increased. The stop of the compressor reduces an engine load, so that the engine speed is increased.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view of an engine control system according to an embodiment of the present invention;

FIG. 2 is a chart for explaining a method of establishing a target track;

FIG. 3 is a flowchart showing a processing of a time synchronization routine;

FIG. 4 is a flowchart showing a processing of a crank angle synchronization routine;

FIG. 5 is a flowchart showing a processing of an engine stop demand determination routine;

FIG. 6 is a flowchart showing a process of an engine start demand determination routine;

FIG. 7 is a flowchart showing a process of a first engine stop control routine;

FIG. 8 is a flowchart showing a process of a reference point learning routine;

FIG. 9 is a flowchart showing a process of a friction learning routine;

FIG. 10 is a flowchart showing a process of a second engine stop control routine;

FIG. 11 is a flowchart showing a process of a stop position control routine;

FIG. 12 is a flowchart showing a process of a first engine start control routine;

FIG. 13 is a chart showing a map of a first ignition cylinder map;

FIG. 14 is a flowchart showing a second engine start control routine;

FIG. 15 is a time chart showing an embodiment of an engine stop control;

FIG. 16 is chart showing a map of a standard Ne2 error upper limit and lower limit

FIG. 17 a chart showing a map of a lower limit ThAltMin of an energy deviation;

FIG. 18 is a chart showing a map of an upper lower limit ThAltMax of an energy deviation;

FIG. 19 is a time chart showing an engine speed behavior in a case that a normal combustion occurs in a first ignition cylinder;

FIG. 20 is a time chart showing an engine speed behavior in a case that a misfire occurs in a fist ignition cylinder;

FIG. 21 is a time chart showing a detected engine speed Ne, actual engine speed, and a detected crank angle; and

FIG. 22 is a chart for explaining a method of computing a feedback correction torque.

### DETAILED DESCRIPTION OF EMBODIMENTS

An embodiment of the present invention will be described hereinafter.

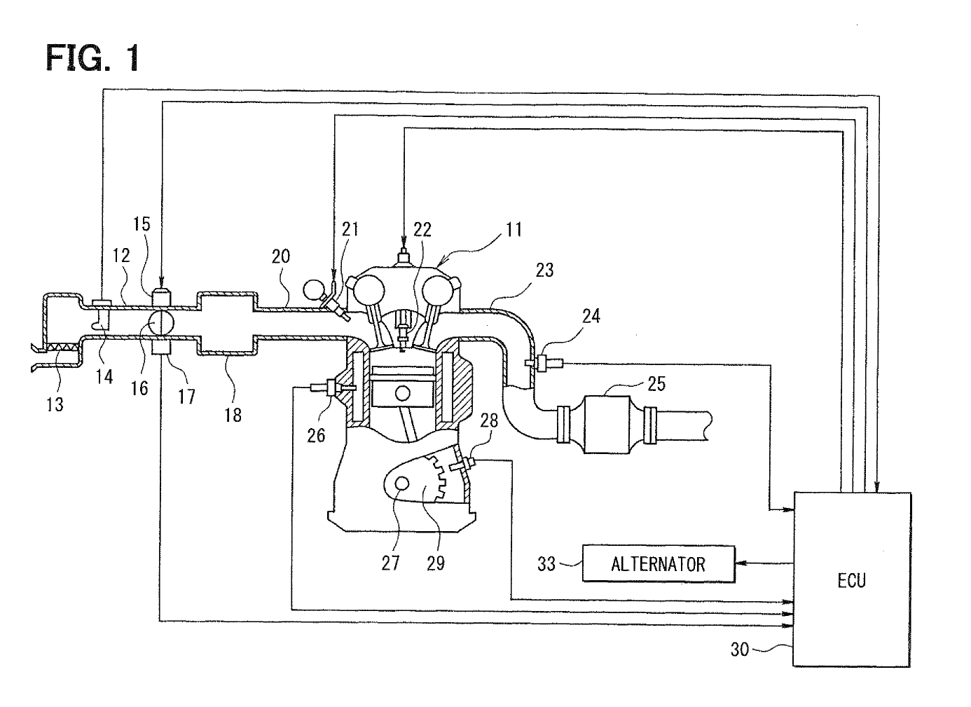

Referring to FIG. 1, an engine control system is explained. An air cleaner 13 is arranged upstream of an intake pipe 12 of an internal combustion engine 11. An airflow meter 14 detecting an intake air flow rate is provided downstream of the air cleaner 13. A throttle valve 16 driven by a DC-motor 15 and a throttle position sensor 17 detecting a throttle position (throttle opening degree) are provided downstream of the air flow meter 14. A surge tank 18 is provided downstream of the throttle valve 16. An intake manifold 20 which introduces air into each cylinder of the engine 11 is connected to the surge tank 18. A fuel injector 21 which injects the fuel is provided at a vicinity of an intake port of the intake manifold 20 of each cylinder. A spark plug 22 is mounted on a cylinder head of the engine 11 corresponding to each cylinder to ignite air-fuel mixture in each cylinder.

An exhaust gas sensor (an air fuel ratio sensor, an oxygen sensor) 24 which detects an air-fuel ratio of the exhaust gas is respectively provided in each exhaust pipe 23, and a three-way catalyst 25 which purifies the exhaust gas is provided downstream of the exhaust gas sensor 24.

A coolant temperature sensor 26 detecting a coolant temperature is disposed on a cylinder block of the engine 11. A signal rotor 29 is connected to a crankshaft 27 of the engine 11. A crank angle sensor 28 confronts the outer portion of the signal rotor 29. The signal rotor 29 has teeth on its outer periphery. When the teeth of signal rotor 29 confront the crank angle sensor 28, the crank angle sensor 28 outputs a crank pulse signal. The engine speed is detected based on a cycle of the output pulse signals. A cam angle sensor (not shown) outputs a cam pulse signal in synchronization with a rotation of a camshaft.

Rotation of the crankshaft 27 is transmitted to the alternator 33 which is an auxiliary machinery of the engine 11 through the belt transfer mechanism (not shown). Thereby, under the power of the engine 11, the alternator 33 rotates and generates electricity. The torque of the alternator 33 is controllable by performing duty control of the power-generation-control electric current (field current) of the alternator 33. The alternator is used as an electric machinery in the present embodiment.

The outputs of the sensors are inputted to an electronic control unit (ECU) 30. The ECU 30 is structured mainly of a microcomputer. The ECU 30 controls a fuel injection quantity and fuel injection timing of the fuel injector 21, and an ignition timing of the spark plug 22. When the automatic stop condition is established during a idling of the engine and an engine stop demand (idle stop demand) is generated, the ECU 30 stops the combustion and executes an idle stop to stop the engine. When a driver operates for starting engine during the engine stop, a specified automatic start condition is established and the starter is energized to start the engine 11 automatically.

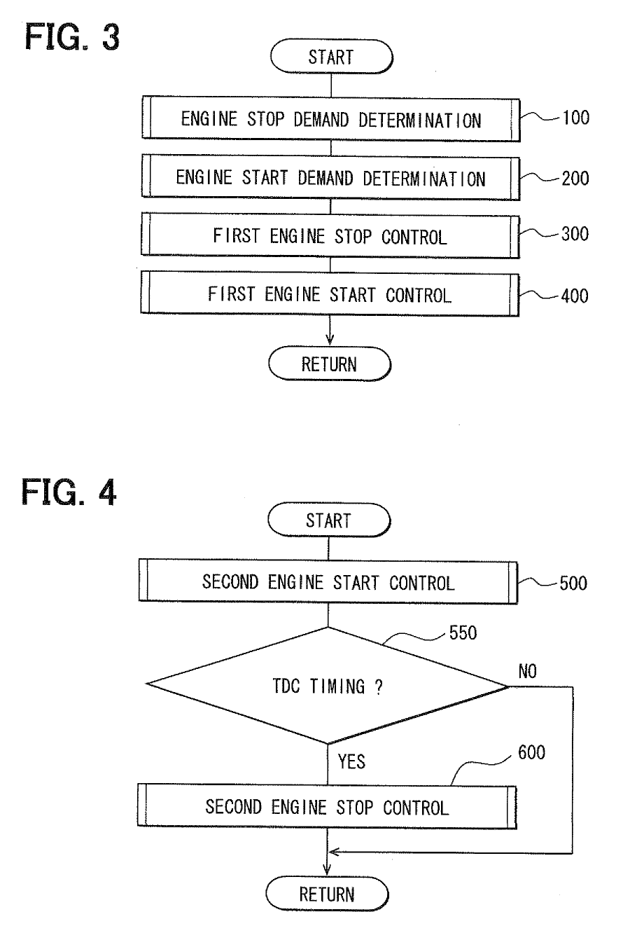

The ECU 30 executes each routine shown in FIGS. 3 to 14, whereby a target engine speed at a reference point TDC which is before a specified crank angle from a target stop position (target stop crank angle) is set. The target track is computed based on the target engine speed and an engine friction. The torque of the alternator 33 is controlled in such a manner that the engine speed behavior agrees with the target track.

The target speed at the reference point is lower than a lower limit value in which the alternator torque is generated. The target speed is lower than a lower limit speed in which the alternator 33 generates torque. In a range from an engine stop operation to the target speed at the reference point, the engine speed behavior agrees with the target track.

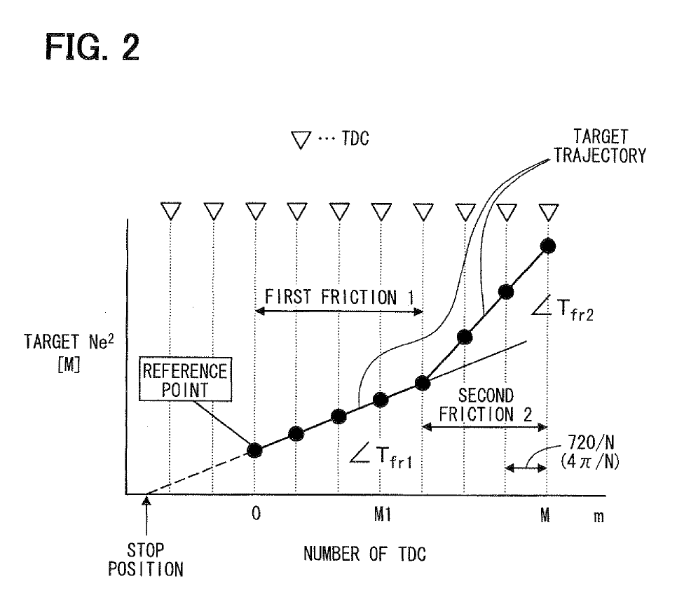

The target track is stored in a table (refer to FIG. 2) in which a target engine speed is computed every TDC from an engine stop operation start to the reference point.

During an engine stop stage, the engine speed is decreased due to an engine friction. By computing the target track based on the engine friction and the target engine speed, the torque of the alternator 33 is controlled in a manner that the actual engine speed behavior agrees with the target track. The actual engine speed at the reference point agrees with the target engine speed. The torque of the alternator 33 does not affect the engine speed behavior. There is not an error of the stop position due to the torque of the alternator. The actual stop position of the engine accurately agrees with the target stop position.

The engine friction characteristic varies according to the auxiliary machinery of the engine 11. An engine friction is selected out of a plurality of engine friction to compute the target track. In FIG. 2, a different engine friction is set between a range from the reference point to M1 and a range from M1 to M.

The engine stop position adjustable range is defined based on an engine rotational angle and alternator torque. Since the alternator torque is not so large, some amounts of the engine stop control period (engine rotational angle) are necessary in order that the engine speed behavior agrees with the target track. When the engine speed becomes excessively small, the engine stop control period can not be ensured. An accuracy of the engine stop position is deteriorated.

According to the present embodiment, when the engine stop demand is generated and the engine speed is lower than a specified value, the engine speed is increased to start the engine stop control. When it is determined that the engine speed is lower than the specified value and the accuracy of the engine stop position is not ensured, the engine speed is increased to obtain the specified engine speed so that the engine stop control is started. Even if the engine speed is low at a demand of engine stop, the engine stop control period is ensured and the engine stop position is controlled to the target stop position.

An ignition timing is advance, a compressor of air conditioner is stopped, an intake air quantity is increased, or a fuel injection quantity is increased in order to increase the engine speed. An advance of the ignition timing, an increase in intake air quantity, and an increase in fuel injection quantity increases the engine torque. This increase in engine torque causes an increase in the engine speed. When the compressor is stopped, the engine load is reduced so that the engine speed is increased.

The ECU 30 executes each routine shown in FIGS. 3 to 14.

### [Time Synchronization Routine]

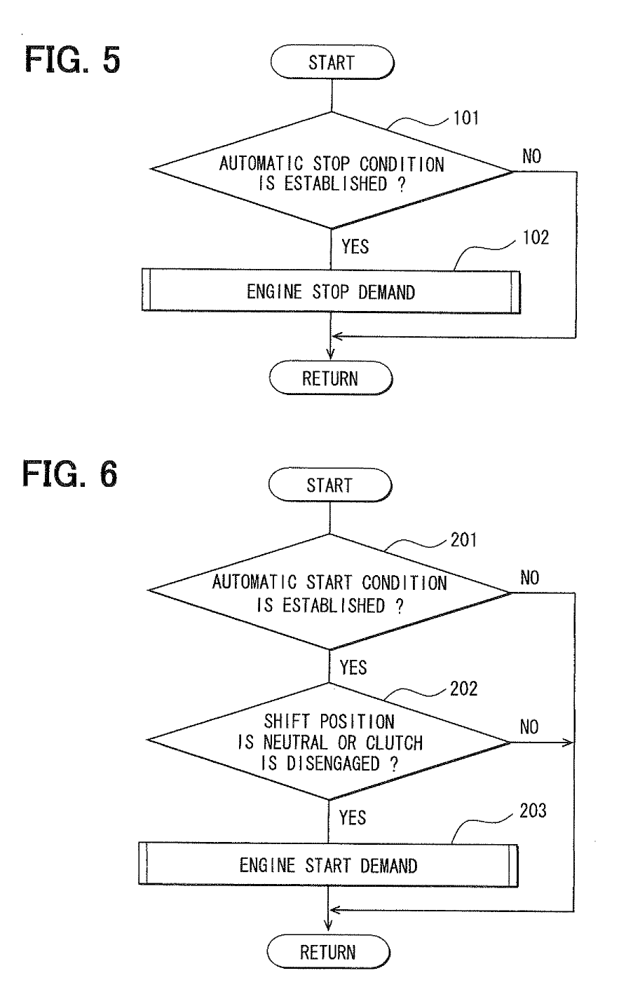

A time synchronization routine shown in FIG. 3 is performed by ECU 30 in a specified interval while the ECU 30 is ON. In step 100, the computer determines whether an engine stop demand (idle stop demand) is generated by executing an engine stop demand determination routine shown in FIG. 5.

In step 200, the computer determines whether an engine start demand (automatic start demand after idle stop) is generated by executing an engine start demand determination routine shown in FIG. 6.

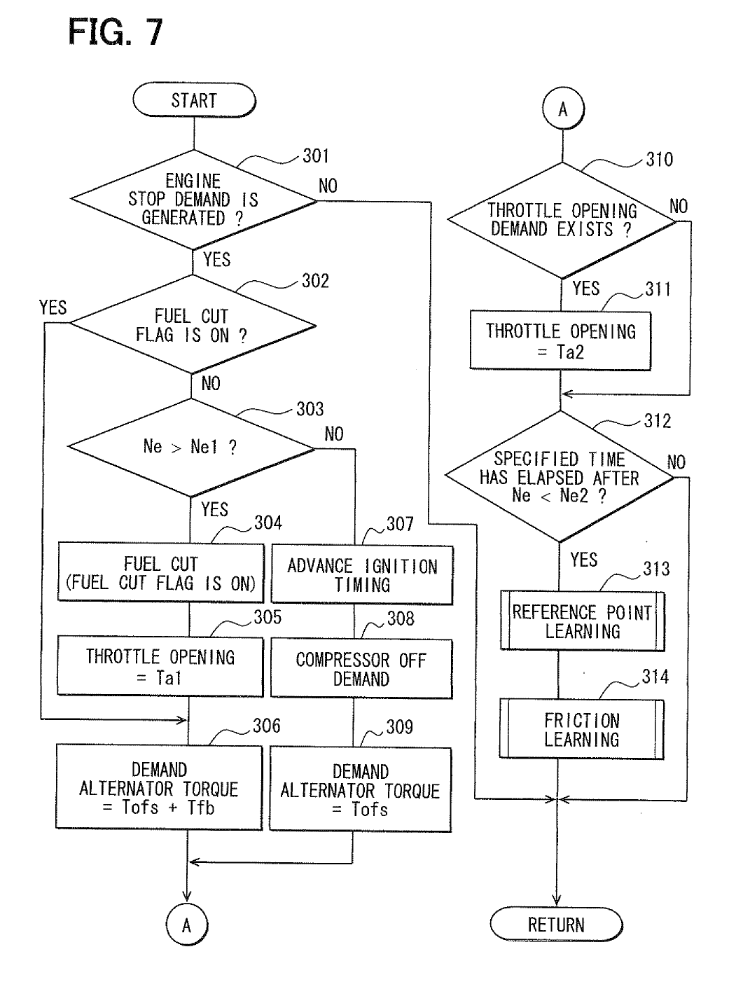

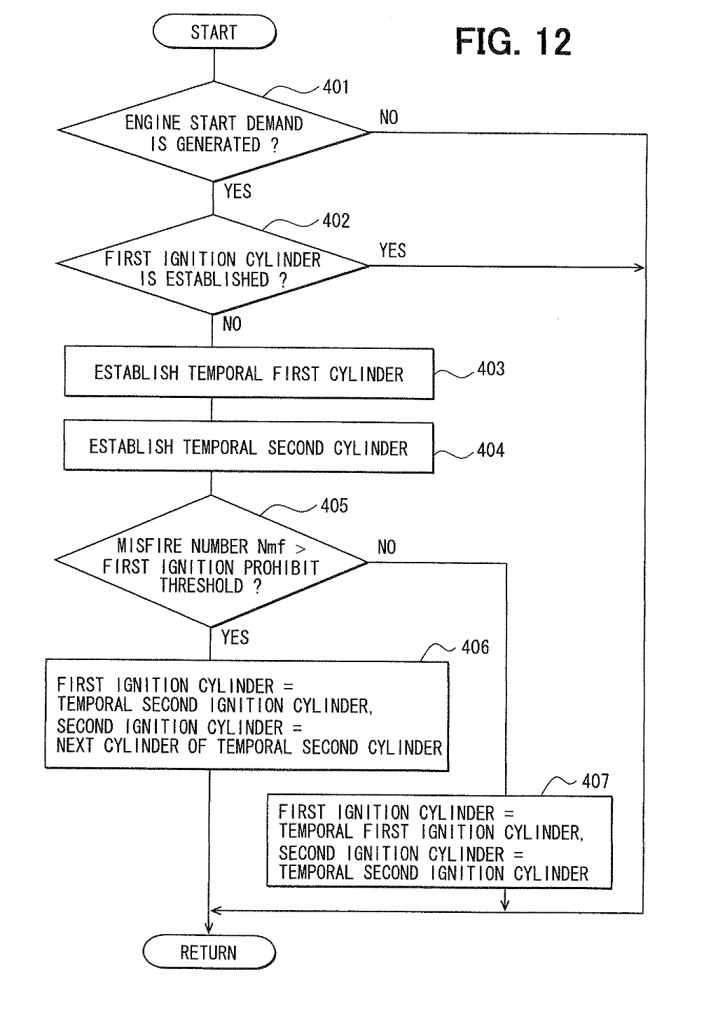

In step 300, a first engine stop control routine shown in FIG. 7 is executed to compute a demand torque of the alternator 33. In step 400, a first engine start control routine shown in FIG. 12 is executed to set a first ignition cylinder and a second ignition cylinder after the automatic start.

### [Crank Angle Synchronization Routine]

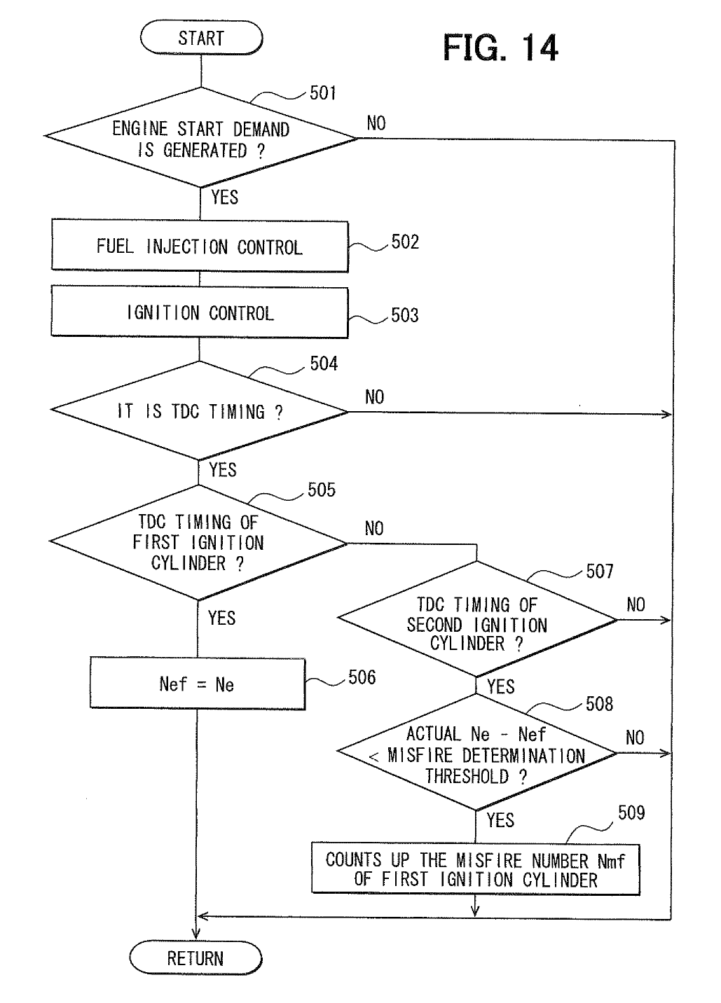

A crank angle synchronization routine shown in FIG. 4 is performed by ECU 30 in a specified interval while the ECU 30 is ON. In step 500, a second engine start control routine shown in FIG. 14 is executed to perform a fuel injection control, an ignition control, a misfire determination of the first ignition cylinder.

In step 550, the computer determines whether it is a TDC timing. When the answer is No, the procedure ends. When the answer is Yes, the procedure proceeds to step 600 in which a second engine stop control routine is executed.

### [Engine Stop Demand Determination Routine]

An engine stop demand determination routine shown in FIG. 5 is a subroutine of step 100 in FIG. 3. In step 101, the computer determines whether an automatic stop condition (idle stop executing condition) is established.

In a manual transmission vehicle, when any one of following condition (a) and (b) is satisfied, the automatic stop condition is established.

(a) A shift position is in forward gear, a vehicle speed is less than a specified speed (for example, less than 10 km/h), a break pedal is stepped (break is ON), and a clutch is disengaged.

(b) A shift position is in neutral and the clutch is engaged.

In an automatic transmission vehicle, when any one of following condition (c) and (d) is satisfied, the automatic stop condition is established.

(c) A shift position is in forward range or in neutral, a vehicle speed is less than a specified speed (for example, less than 10 km/h), and a break pedal is stepped (break is ON).

(d) A shift position is in parking range.

When the answer is No in step 101, the procedure ends. When the answer is Yes in step 101, the procedure proceeds to step 102 in which an engine stop demand is outputted.

### [Engine Start Demand Determination Routine]

The engine start demand determination routine shown in FIG. 6 is a subroutine of step 200 in FIG. 3. In step 201, the computer determines whether an automatic start condition is established.

In a manual transmission vehicle, when any one of following conditions (a) and (b) is satisfied, the automatic start condition is established.

(a) A shift position is in forward gear, and a break pedal is not stepped (break is OFF) or a clutch is engaged.

(b) A shift position is in neutral and the clutch is disengaged.

In an automatic transmission vehicle, when following condition (c) is satisfied, the automatic start condition is established.

(c) A shift position is in other than parking range and the brake pedal is not stepped (break is OFF).

When the answer is No in step 201, the procedure ends. When the answer is Yes in step 201, the procedure proceeds to step 202 in which the computer determines whether the shift position is neutral or whether a clutch is disengaged. When the answer is No in step 202, the procedure ends.

When the answer is Yes in step 202, the procedure proceeds to step 203 in which an engine start demand is generated.

### [First Engine Stop Control Routine]

The first engine stop control routine shown in FIG. 7 is a subroutine of step 300 and corresponds to an engine speed accelerator. In step 301, the computer determines whether an engine stop demand is generated based on a result of the engine stop demand determination routine of FIG. 5. When the answer is No in step 301, the procedure ends.

When the answer is Yes in step 301, the procedure proceeds to step 302 in which the computer determines whether a fuel cut flag is On. When the answer is No in step 302, the procedure proceeds to step 303 in which the computer determines whether a current engine speed Ne is greater than a specified value Ne1.

When the answer is Yes in step 303, the procedure proceeds to step 304 in which a fuel cut flag is set On and the fuel cut is conducted. In step 305, a throttle opening is set to a first value Ta1. In step 306, a demand alternator torque is set by adding an offset torque Tofs to a feedback correction torque Tfb. Demand alternator torque=Tofs+Tfb

The offset torque Tofs is set half of a maximum torque which the alternator 33 can control. The alternator 33 virtually controls its torque in positive or negative way. The torque under the offset torque Tofs is virtually negative torque, and the torque over the offset torque Tofs is virtually positive torque. The engine speed behavior follows the target track.

Besides, the offset torque Tofs may be ⅓, ¼, ⅔, or ¾ of the maximum torque. The offset torque is smaller than the maximum torque and larger than zero.

0<Tofs<Maximum torque

When the answer is Yes in step 302, the procedure proceeds to step 306.

When the answer is No in step 303, the procedure proceeds to step 307 in which the ignition timing is advanced to a knock limit. Thereby, the engine torque is increased and the engine speed is increased. In step 308, a compressor OFF demand is generated (compressor off flag is turned On) to turn off the compressor of the air conditioner. Thereby, the engine load is reduced and the engine speed Ne is increased. Alternatively, by increasing intake air quantity or fuel injection quantity, the engine speed can be increased. Then, the procedure proceeds to step 309 in which demand alternator torque is set as the offset torque Tofs. Demand alternator torque=Tofs

Then, the procedure proceeds to step 310 in which the computer determines whether a throttle opening demand exists. When the answer is Yes in step S310, the procedure proceeds to step 311 in which the throttle opening is set to a second value Ta2 which is larger than the first value Ta1. When the answer is No in step 310, the process in step 311 is not executed and the throttle opening is maintained as the first value Ta1.

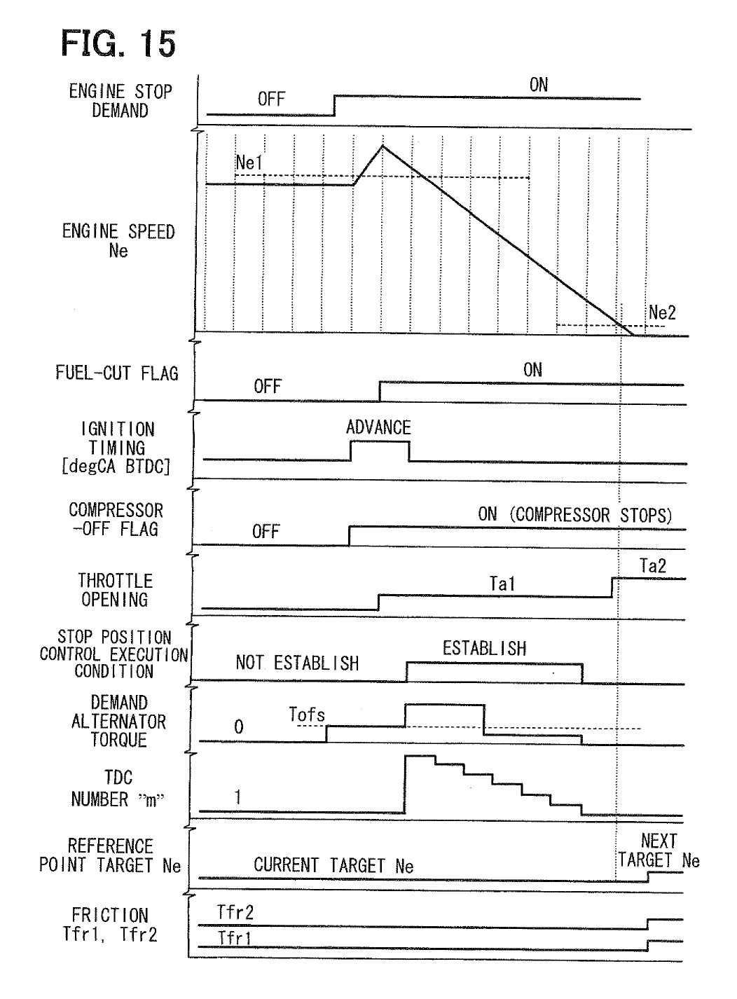

Then, the procedure proceeds to step 312 in which a specified time has elapsed after the engine speed Ne becomes the engine speed Ne2 just before engine stop. As shown in FIG. 15, the engine speed Ne2 corresponds to an engine speed just before the engine stop after the TDC.

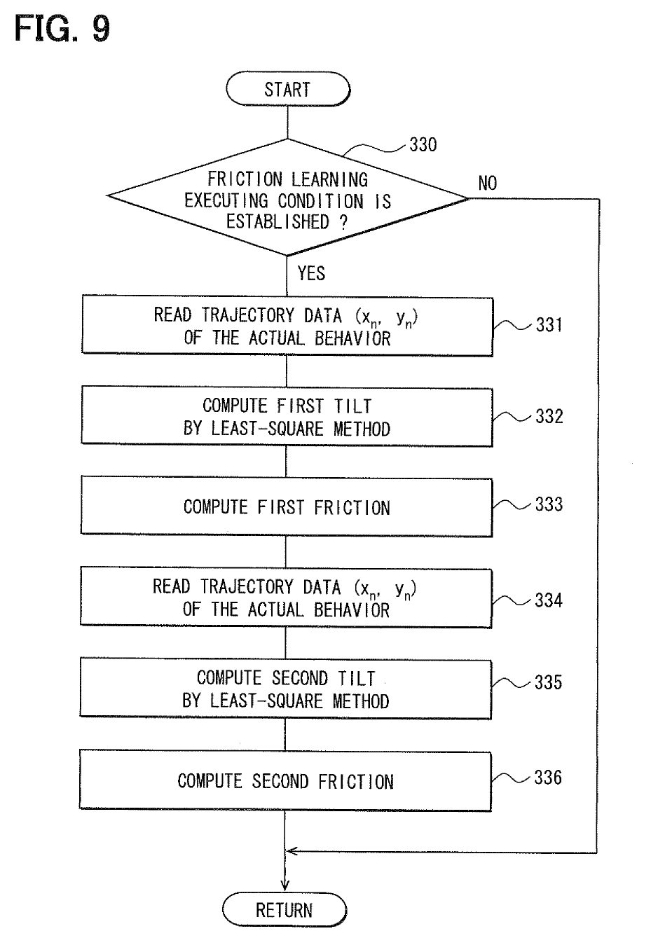

When the answer is No in step 312, the procedure ends. When the answer is Yes in step 312, the procedure proceeds to step 313 in which a reference point learning routine is conducted to compute a target engine speed Ne of next reference point. Then, the procedure proceeds to step 314 in which a friction learning routine shown in FIG. 9 is executed to learn a first and second friction (Tfr1, Tfr2).

### [Reference Point Learning Routine]

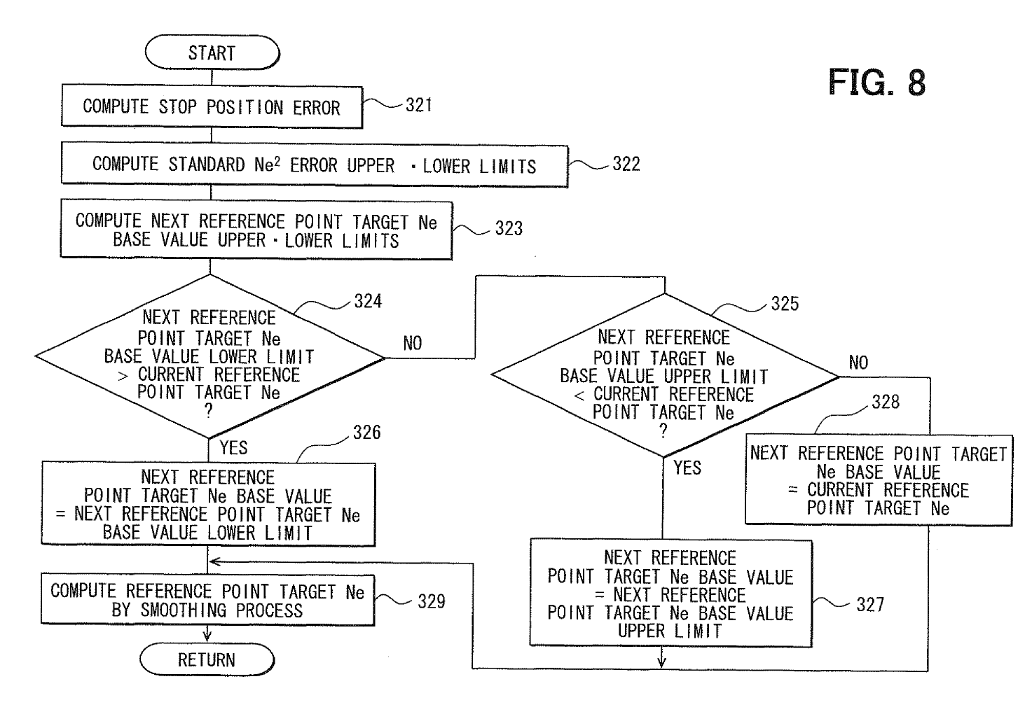

A reference point learning routine shown in FIG. 8 is a subroutine of step 313 in FIG. 7. In step 321, a stop position error is computed based on the following formula.

Stop position error=(actual stop position crank angle−current reference point crank angle)mod 720+{(720/N)×K−target stop position crank angle}

Besides, (actual stop position crank angle−current reference point crank angle)mod 720 is a remainder crank angle when (actual stop position crank angle−current reference point crank angle) is divided by 720[deg CA]. For example, when (actual stop position crank angle−current reference point crank angle) is 1000 [degCA], (1000)mod 720=280 [degCA]

When (actual stop position crank angle−current reference point crank angle) is 400 [degCA], (400)mod 720=400 [degCA] In the above formula, N represents a cylinder number and K represents a number of TDC which passed from the current reference point to an actual stop position.

Then, the procedure proceeds to step 322 in which a standard Ne² error upper·lower limits are computed according to the stop position error in accordance with a standard Ne² error upper·lower map.

Standard Ne² error upper limit=Standard Ne² error upper limit map (stop position error)

Standard Ne² error lower limit=Standard Ne² error lower limit map (stop position error)

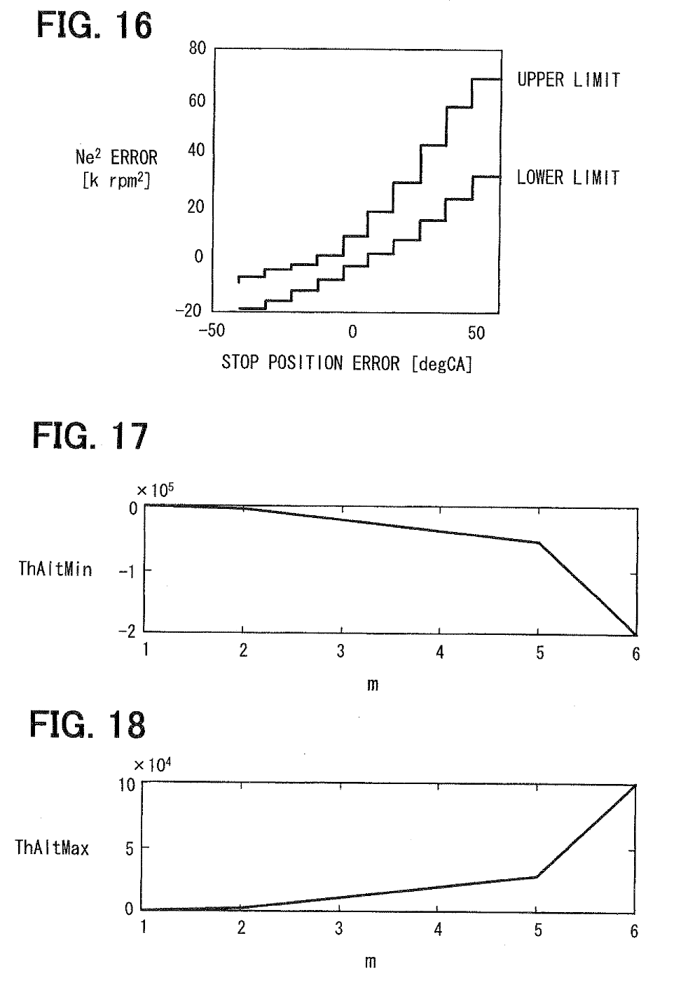

As shown in FIG. 16, as the stop position error becomes large, the standard Ne² error upper·lower limit becomes large.

Then, the procedure proceeds to step 323 in which next reference point target Ne² base value upper·lower limits are computed based on the following formula.

Next reference point target Ne base value upper limit=√(current reference point actual Ne²−standard Ne² error lower limit)

Next reference point target Ne base value lower limit=√(current reference point actual Ne²−standard Ne² error upper limit)

Then, the procedure proceeds to step 324 in which the next reference point target Ne base value lower limit is compared with the current reference point target Ne. When the next reference point target Ne base value lower limit is greater than the current reference point target Ne, the procedure proceeds to step 326 in which the next reference point target Ne base value lower limit is used as the next reference point target Ne base value.

Next reference point target Ne base value=Next reference point target Ne base value lower limit

When it is determined that the next reference point target Ne base value lower limit is lower than the current reference point target Ne, the procedure proceeds to step 325. In step 325, the next reference point target Ne base value upper limit is compared with the current reference point target Ne. When the next reference point target Ne base value upper limit is less than the current reference point target Ne, the procedure proceeds to step 327 in which the next reference point target Ne base value upper limit is used as the next reference point target Ne base value.

Next reference point target Ne base value=Next reference point target Ne base value upper limit

When the answer is No in steps 324 and 325, the procedure proceeds to step 328 in which the current reference point target Ne is used as the next reference point target Ne base value.

Next reference point target Ne base value=Current reference point target Ne

In any one of steps 326 to 328, the next reference point target Ne base value is set. Then, the procedure proceeds to step 329 in which the next reference point target Ne is obtained by a smoothing process.

Next reference point target Ne=Current reference point target Ne−γ·(Current reference point target Ne−Next reference point target Ne base value)

wherein γ is a smoothing coefficient. 0<γ≦1

### [Friction Learning Routine]

A friction learning routine shown in FIG. 9 is a subroutine of step 314 in FIG. 7. In step 330, the computer determines whether a friction learning executing condition is established based on whether the stop position control mode=1 (feedback correction torque Tfb=0).

When the answer is Yes in step 330, the procedure proceeds to step 331 in which a track data (xₙ, yₙ) of the actual behavior in a range (0-M1) where a first friction (Tfr1) is computed is read.

xₙ={0, 720/N, . . . , (720/N)×M₁}

yₙ={a reference point actual Ne², m=1 actual Ne², . . . , m-M₁ actual Ne²}

The xₙ is a crank angle from a reference point to each TDC, and yₙ is actual Ne² in a first friction range. N is a cylinder number of the engine 11, M₁ is a starting point of the first friction.

Then, the procedure proceeds to step 332 in which a first tilt is computed by a least-square method.

$$First tilt = \frac{n {\sum }_{k = 1}^{n} {x}_{k} {y}_{k} - {\sum }_{k = 1}^{n} {x}_{k} {\sum }_{k = 1}^{n} {y}_{k}}{n {\sum }_{k = 1}^{n} {x}_{k}^{2} - {( {\sum }_{k = 1}^{n} {x}_{k} )}^{2}}$$

wherein n=M₁+1

Then, the procedure proceeds to step 333 in which first friction (Tfr1) is computed according to the following formula.

Tfr1=(π·I/10)×first tilt

wherein I represents an engine inertia moment [kgm].

Then, the procedure proceeds to step 334 in which track data (xₙ, yₙ) of the actual behavior in a range (M1-M) where a second friction (Tfr2) is computed is read.

xₙ={0, 720/N, . . . , (720/N)×(M-M1)}

yₙ={actual Ne² at M1, actual Ne² at m=M1+1, . . . , actual Ne² at m=M}

xₙ is a crank angle of each TDC (M1-M) for computing the second friction,

yₙ is the actual Ne² of each TDC for the second friction.

Then, the procedure proceeds to step 335 in which a second tilt is computed. In step 336, the second friction (Tfr2) is computed according to the following formula.

Tfr2=(π·I/10)×second tilt

Besides, the friction is computed based on experiment data or design date beforehand, and stored in a memory such as ROM of the ECU 30.

### [Second Engine Stop Control Routine]

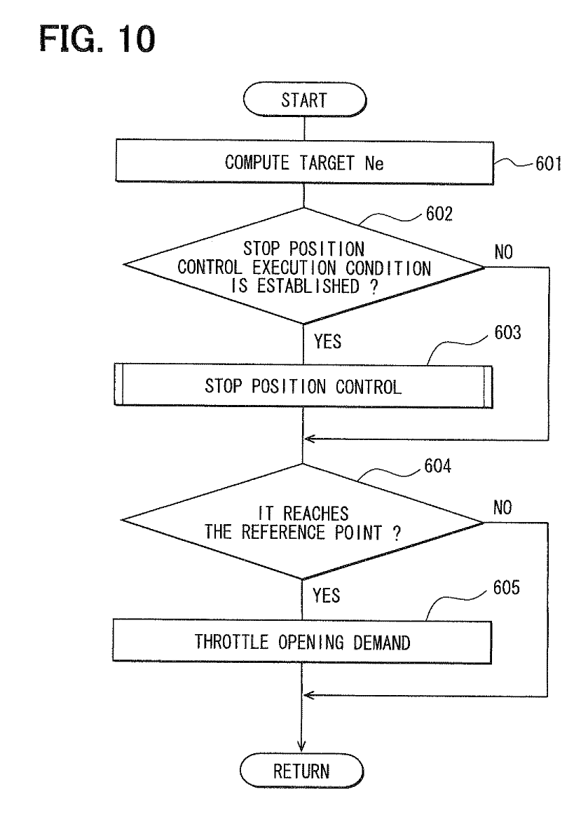

A second engine stop control routine shown in FIG. 10 is a subroutine of step 600 in FIG. 4. In step 601, the target Ne is computed.

A target Ne² [M] in a first friction range and a second friction range is computed.

The target Ne²[M]={10/(π·I)}×[0,720Tfr1/N,(720Tfr1/N)×2----, (720Tfr1/N)M₁,(720Tfr2/N)×(M₁+1)----, (720Tfr2/N)×(M−1)+reference point target Ne2

The engine inertia moment and the friction Tfr have a following relationship.

(½)·I·ω2=Tfr·⊖

wherein ω is angular speed [rad/s] and ⊖ is a rotational angle [rad].

ω=(2π/60)·Ne

⊖=(π/180)·θ

θ: rotational angle [deg]

Based on the above formula, a following formula is derived.

Ne2=(10/π·I)·Tfr·θ

The target Ne² [M] is computed.

After the target Ne² [M] is computed, “m” which satisfy the following formula is obtained.

Target Ne² [m]-(target Ne² [m]-target Ne² [m−1]) (1-α)≦actual Ne²<target Ne² [m]+(target Ne² [m+1]-target Ne² [m])α

wherein 0≦α≦1. “m” represents TDC position which is currently controlled.

Then, the target Ne is computed based on the target Ne².

Target Ne=√target Ne²

As the actual Ne is decreased, the target Ne of each TDC is computed based on the friction Tfr1, Tfr2 and a reference point target Ne, and the target track is set.

After the target Ne is computed, the procedure proceeds to step 602 in which it is determined whether a stop position control execution condition is established. When the following condition (a) and (b) are satisfied, the stop position control execution condition is established.

(a) The number of TDC after fuel cut is more than a specified value (for example, 2).

(b) 1<m<specified value (for example 15)

wherein “m” is a TDC number.

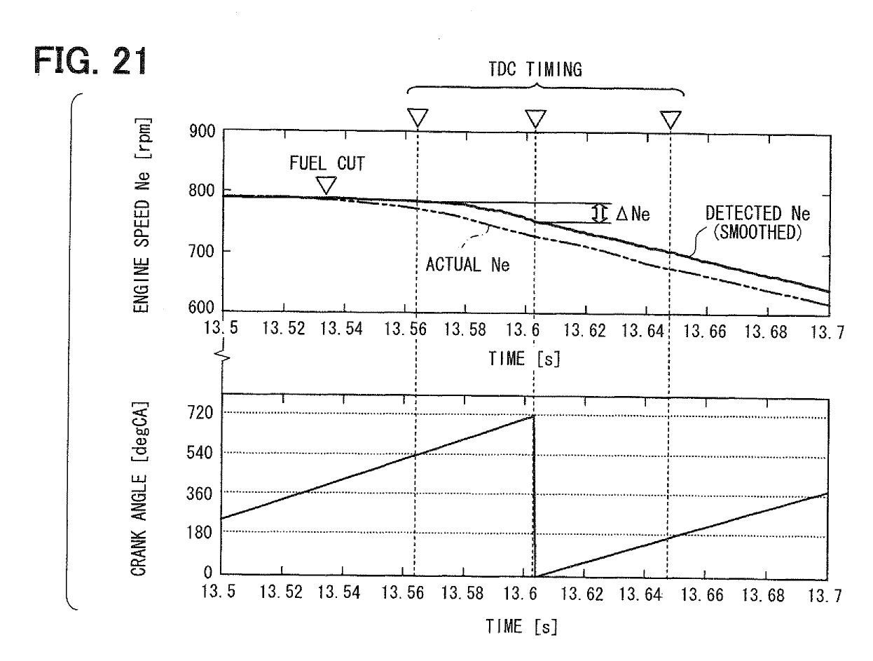

The reason of the condition (a) is that, as shown in FIG. 21, just after fuel cut, decreasing value ΔNe of the engine speed Ne is smaller than the actual value due to a smoothing process of the engine speed Ne.

The reason of the condition (b) is follows. That is, it is unnecessary to start a stop position control from the TDC which is far from the reference point. Besides, when the engine speed is excessively high, it is difficult to conduct the stop position control.

If any one of the condition (a) and (b) is not satisfied, the stop position control is not executed.

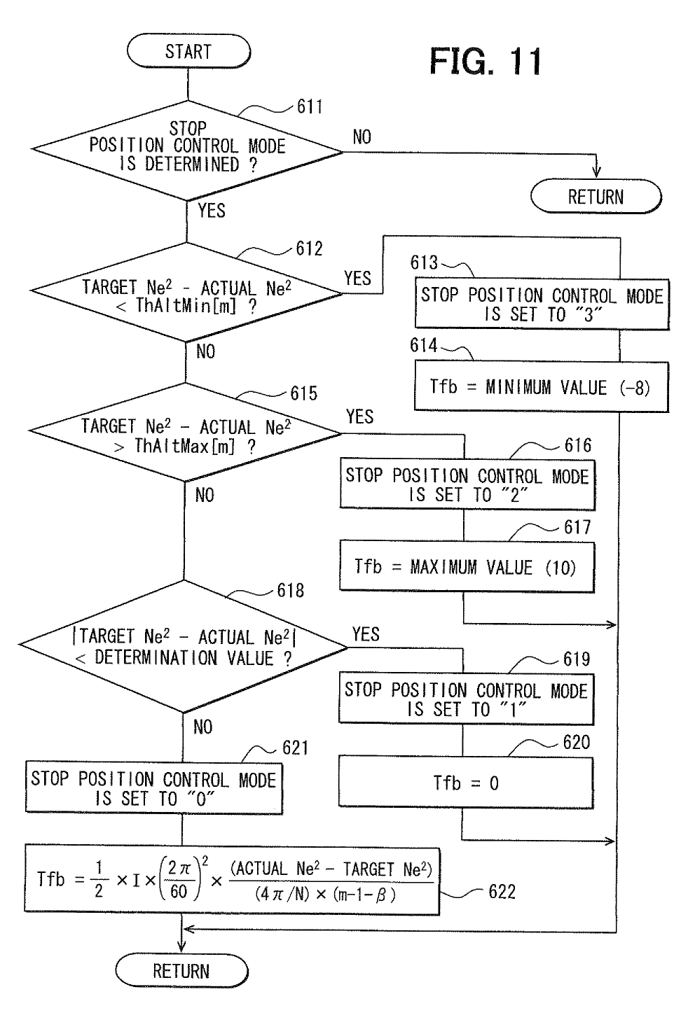

When the conditions (a) and (b) are satisfied, the stop position control execution condition is established. The procedure proceeds to step 603 in which a stop position control routine shown in FIG. 11 is executed to compute the feedback correction torque Tfb of the demand alternator torque.

Then, the procedure proceeds to step 604 in which it is determined whether it reaches the reference point. When the answer is No, the procedure ends. When the answer is Yes, the procedure proceeds to step 605 in which the throttle opening demand is generated. The throttle opening is set to the second value Ta2 which is larger than the first value Ta1.

The opening timing of the throttle is synchronized with the TDC. In step 604, it is determined whether a previous “m” is 2. When the previous “m” is 2, the throttle opening demand can be output.

### [Stop Position Control Routine]

A stop position control routine shown in FIG. 11 is a subroutine of step 603 in FIG. 10. In step 611, the computer determines whether the stop position control mode is determined. When the answer is Yes, the procedure ends.

When the answer is No, the procedure proceeds to step 612 in which it is determined whether a difference between the target Ne² and the actual Ne² is smaller than a lower limit ThAltMin based on a map of the lower limit value ThAltMin shown in FIG. 17. When the answer is Yes in step 612, the procedure proceeds to step 613 in which the stop position control mode is set to “3”, In step 614, the feedback correction torque Tfb of the demand alternator torque is set to a minimum value (for example, −8).

When the answer is No in step 612, the procedure proceeds to step 615 in which it is determined whether a difference between the target Ne² and the actual Ne² is larger than a upper limit ThAltMax based on a map of the upper limit value ThAltMax shown in FIG. 18. When the answer is Yes in step 615, the procedure proceeds to step 616 in which the stop position control mode is set to “2”. In step 617, the feedback correction torque Tfb of the demand alternator torque is set to a maximum value (for example, 10).

When the answer is No in step 615, the procedure proceeds to step 618 in which it is determined whether an absolute value of a difference between the target Ne² and the actual Ne² is smaller than a determination value (for example, 5000). When the answer is Yes in step 618, the procedure proceeds to step 619 in which the stop position control mode is set to “1”. In step 620, the feedback correction torque Tfb of the demand alternator torque is set to “0”. The first friction and a second friction (Tfr1, Tfr2) can be learned in a condition where the torque of the alternator is fixed at the offset torque Tofs.

When the answer is No in step 618, the procedure proceeds to step 621 in which the stop position control mode is set to “0”. In step 622, the feedback correction torque Tfb of the demand alternator torque is computed according to the following formula.

Tfb=(½)×I×(2π/60)²×(actual Ne²−target Ne²)÷{(4π/N)×(m−1−β)}

wherein β is an adjustment parameter to compute crank angle in which the torque of the alternator 33 is not generated (0≦β≦1).

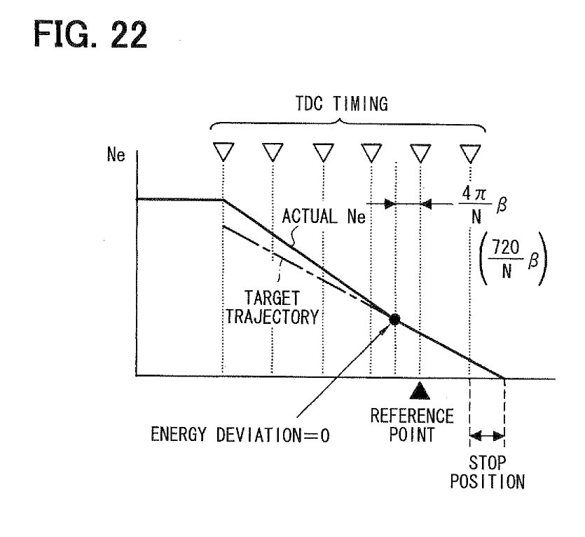

As shown in FIG. 22, the torque of the alternator 33 is not generated just before a specified crank angle [(4π/N)×β]. The feedback correction torque Tfb is computed in a manner that the difference between target Ne² and the actual Ne² becomes zero just before the specified crank angle [(4π/N)×β]. The position just before the crank angle [(4π/N)×β] is set at a position where the actual Ne is lower limit speed. The position can be set at a position where the actual Ne is a higher than the lower limit speed.

Based on the stop position control mode, the feedback correction torque Tfb of the demand alternator torque is set as follows.

(A) When the difference between the target Ne² and the actual Ne² is smaller than the lower limit ThAltMin, the stop position control mode is set to “3” and the feedback correction torque Tfb is set minimum value (for example, −8).

(B) When the difference between the target Ne2 and the actual Ne2 is larger than the upper limit ThAltMax, the stop position control mode is set to “2” and the feedback correction torque Tfb is set maximum value (for example, 10).

When the difference between the target Ne² and the actual Ne² exceeds the upper and lower limit, the feedback correction torque Tfb is fixed at maximum value or minimum value.

(C) When the absolute value of a difference between the target Ne² and the actual Ne² is smaller than a determination value, the stop position control mode is set to “1” and the feedback correction torque Tfb is set to “0”. Thereby, the first and second friction (Tfr1, Tfr2) can be learned in a condition where a feedback control of the torque of the alternator 33 is prohibited.

(D) Other than the above, the stop position control mode is set to “0”, and the feedback correction torque Tfb is computed.

### [First Engine Start Control Routine]

A first engine start control routine shown in FIG. 12 is a subroutine of step 400 in FIG. 3. In step 401, the computer determines whether an engine start demand is generated. When the answer is No, the procedure ends.

When the answer is Yes in step 401, the procedure proceeds to step 402 in which it is determined whether a first ignition cylinder is established. When the answer is Yes in step 402, the procedure ends.

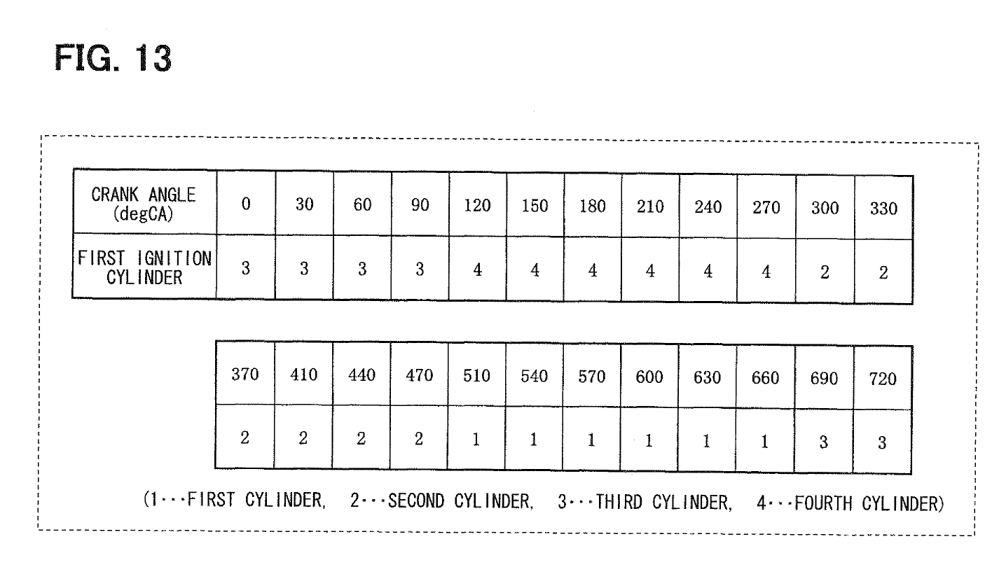

When the answer is No in step 402, the procedure proceeds to step 403 in which a temporal first cylinder corresponding to a crank angle of the stop position is established based on a first ignition cylinder map shown in FIG. 13. According to the present embodiment, the crank angle of the stop position is a crank position of the target stop position. Then, the procedure proceeds to step 404 in which a temporal second cylinder is established.

In step 405, it is determined whether a misfire number Nmf is larger than a first ignition prohibit threshold. When the answer is Yes in step 405, the procedure proceeds to step 406 in which the temporal second ignition cylinder becomes the first ignition cylinder and the next cylinder of the temporal second cylinder becomes the second ignition cylinder.

When the answer is No in step 405, the procedure proceeds to step 407 in which the temporal first ignition cylinder becomes the first ignition cylinder and the temporal second ignition cylinder becomes the second ignition cylinder.

### [Second Engine Start Control Routine]

A second engine start control routine shown in FIG. 14 is a subroutine of step 500 in FIG. 4. In step 501, it is determined whether an engine start demand is generated. When the answer is No in step 501, the procedure ends.

When the answer is Yes, the procedure proceeds to step 502 in which a fuel injection control is performed. In step 503, an ignition control is performed.

Then, the procedure proceeds to step 504 in which the computer determines whether it is a TDC timing. When the answer is No in step 504, the procedure ends. When the answer is Yes in step 504, the procedure proceeds to step 505 in which the computer determines whether it is a TDC timing of the first ignition cylinder. When the answer is Yes in step 505, the procedure proceeds to step 506 in which actual Ne is stored in the memory as the Nef.

When the answer is No in step 505, the procedure proceeds to step 507 in which the computer determines whether it is a TDC timing of the second ignition cylinder. When the answer is No, the procedure ends.

When the answer is Yes in step 507, the procedure proceeds to step 508 in which the computer determines whether a difference between the actual Ne and the rotational speed Nef is less than a misfire determination threshold.

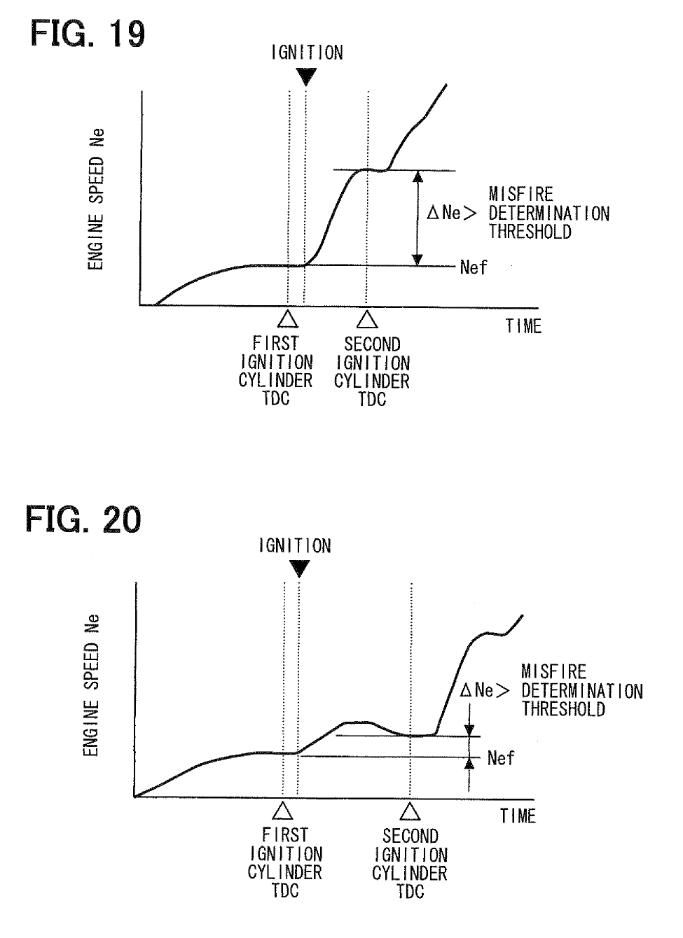

As shown in FIG. 19, when the normal combustion occurs in the first ignition cylinder, the difference ΔNe between the actual Ne in the second ignition cylinder and the actual Ne (=Nef in the first ignition cylinder becomes large. As shown in FIG. 20, when the misfire occurs in the first ignition cylinder, the actual Ne does not increase, Thus, the difference ΔNe becomes small. When the answer is Yes in step 508, the procedure proceeds to step 509 in which a misfire-number counter counts up the misfire number Nmf of the first ignition cylinder. The misfire-number counter is provided to each cylinder. When the difference ΔNe is larger than the misfire determination threshold, a normal combustion occurs in the first ignition cylinder.

FIG. 15 is a time chart showing an embodiment of the engine stop control. In this time chart, when the engine stop demand is generated, the engine speed Ne is lower than the specified value Ne1. The ignition timing is advanced to increase the engine torque, and the compressor-OFF flag is turned On to stop the compressor to reduce the load of the engine 11 so that the engine speed Ne is increased.

When the engine speed Ne exceeds the specified value Ne1, the fuel-cut flag is turned On to perform the fuel cut. The throttle opening is set to the specified value Ta1. When the stop position control execution condition is established, the stop position control is started and the demand alternator torque is established based on the offset torque Tofs and the feedback correction torque Tfb.

Demand alternator torque=Tofs+Tfb

Besides, the alternator torque is set to offset torque Tofs when the engine stop demand is generated.

After that, when the stop position control execution condition is not established, the demand alternator torque becomes zero. When it is a reference point, the throttle opening is set to Ta2. When a predetermined time has passed after the engine speed Ne is decreased lower than the Ne2, a next reference point target Ne is learned based on a stop position error and the frictions Tfr1, Tfr2 are learned.

According to the present embodiment, even if the engine speed Ne is low when the engine stop demand is generated, the engine stop control period can be ensured so that the engine stop position is accurately controlled to the target stop position.

An effect of compression arises in a low engine speed region. According to the present embodiment, the target track can be established in a region before the effect of compression arises. At the reference point, the actual Ne can accurately coincide with the target Ne. The target Ne of the reference point is established at an engine speed which is necessary to stop the engine at the target stop position from the reference point. When the actual Ne agrees with the target Ne accurately, the actual stop position of the engine agrees with the target stop position with high accuracy.

According to the present embodiment, since the target Ne is set lower than a lower limit of the speed range in which the torque of the alternator 33 is generated, no effect of the torque of the alternator is generated in the engine speed behavior and an stop position error due to the torque of the alternator 33 can be disappeared. The accuracy of the stop position can be improved.

It is conceivable that the stop position error is generated by an error of the target Ne at the reference point. According to the present embodiment, the target Ne is corrected based on the error of the stop position, the accuracy of the target Ne at a reference point is improved.

The cylinder pressure in each cylinder operates in a direction in which the engine rotation is restricted in a compression stroke, and operates in a direction in which the engine rotation is facilitated in a power stoke. A balance of a motion energy of the cylinder pressure in each TDC is zero. According to the present embodiment, since the target track is established for each TDC, the target track is accurately established.

The target track can be established for specified crank angle.

The way of establishing the target track can be suitably changed. The target track can be corrected according to the target stop position and an effect of compression.

In the above embodiment, the torque of the alternator 33 is controlled during the engine stop control. Alternatively, an electric motor other than the alternator, such as a generator motor in hybrid vehicle, can be controlled.

What is claimed is:

1. An engine stop control apparatus performing an engine stop control by a torque of an electric machinery in a manner that an engine stop position is controlled to a target stop position at a time of stopping an engine according to an engine stop demand, the engine stop control apparatus comprising;
an engine speed accelerator which starts the engine stop control after increasing an engine speed once when an engine stop demand is generated and the engine speed is lower than a specified value.

2. An engine stop control apparatus according to claim 1, wherein the engine speed accelerator includes a means for advancing an ignition timing to accelerate the engine speed.

3. An engine stop control apparatus according to claim 1, wherein the engine speed accelerator includes a means for stopping a compressor of an air conditioner which is driven by the engine to accelerate the engine speed.

4. An engine stop control apparatus according to claim 1, wherein the engine speed accelerator includes a means for increasing an intake air quantity to accelerate the engine speed.

5. An engine stop control apparatus according to claim 1, wherein the engine speed accelerator includes a means for increasing a fuel injection quantity to accelerate the engine speed.
